(19) United States
(12) Patent Application Publication
(10) Pub. No.: US 2019/0037373 A1
(43) Pub. Date: Jan. 31, 2019

(54) METHOD AND APPARATUS AND COMPUTER PROGRAM PRODUCT FOR UPGRADING A TO-BE-UPGRADED DEVICE

(71) Applicant: BOE TECHNOLOGY GROUP CO., LTD., Beijing (CN)

(72) Inventor: Zhusong YI, Beijing (CN)

(21) Appl. No.: 15/941,127

(22) Filed: Mar. 30, 2018

(30) Foreign Application Priority Data
Jul. 28, 2017 (CN) 201710631210.4

(51) Int. Cl. H04W 4/50; H04L 29/08

(52) U.S. Cl. CPC H04W 4/50; H04W 4/80; H04L 67/34

(57) ABSTRACT

A method for upgrading a to-be-upgraded device is disclosed. The method includes receiving upgrade data in a cable digital television signal format which is required for upgrading the to-be-upgraded device at a predetermined frequency point via a cable digital television interface, processing the upgrade data and converting it into a format readable to the to-be-upgraded device, and sending it to the to-be-upgraded device via a short-range wireless network. An apparatus for upgrading a to-be-upgraded device and a computer program product are also disclosed.

### RELATED APPLICATIONS

This application claims the benefit of Chinese patent application No. 201710631210.4 filed on Jul. 28, 2017, the entire disclosure of which is incorporated herein by reference.

### TECHNICAL FIELD

The disclosure relates to the technical field of electronic device, and in particular, to a cable digital television network conversion device and an upgrade method for a system and/or software based thereon.

### BACKGROUND

To achieve a richer and more complete function, system and/or software upgrade will generally be conducted for a smart device with an operating system. For example, as compared to the previous version, the upgraded system can make up for the system vulnerabilities of the previous version, and improve the system compatibility, and the use experience is smoother. Nowadays, the upgrade of the system and/or software of a smart device is mainly to connect to the internet via for example a 4G network signal, or a routing wifi signal of a broadband network, download the upgrade package of the system and/or software to the local, and then perform the upgrade operation of the system and/or software. However, if the smart device cannot be connected to the internet, the upgrade of the system and/or software cannot be accomplished.

### SUMMARY

An embodiment of a first aspect of the disclosure proposes a method for upgrading a to-be-upgraded device, which includes the following steps: receiving upgrade data in a cable digital television signal format which is required for upgrading the to-be-upgraded device at a predetermined frequency point via a cable digital television interface, processing the upgrade data and converting it into a format readable to the to-be-upgraded device, and sending it to the to-be-upgraded device via a short-range wireless network.

In an example, the processing includes: demodulating the received upgrade data.

In an example, the processing further includes: parsing the demodulated upgrade data utilizing a user predetermined parameter value, to get data related with the user predetermined parameter value.

In an example, the predetermined parameter is the parameters PID and Table ID in the DVB-C standard.

In an example, the method further includes requesting corresponding upgrade data via the cable digital television interface utilizing a user predetermined parameter value.

In an example, the method further includes: querying whether the to-be-upgraded device is installed with an upgrade application which facilitates the upgrade of the to-be-upgraded device and it is the latest, and correspondingly sending data for installing or upgrading the upgrade application to the to-be-upgraded device in response to a negative query result.

An embodiment of a second aspect of the disclosure proposes an apparatus for upgrading a to-be-upgraded device, which includes: a storage configured to store an instruction, a communication interface configured to be capable of communicating with the to-be-upgraded device via a short-range wireless communication network and communicating via a cable digital television interface, and a processor configured to, when executing the instruction, enable implementation of the following steps: receiving upgrade data in a cable digital television signal format which is required for upgrading the to-be-upgraded device at a predetermined frequency point via the cable digital television interface, processing the upgrade data and converting it into a format readable to the to-be-upgraded device, and sending it to the to-be-upgraded device via a short-range wireless network. In an example, the processing includes: demodulating the received upgrade data.

In an example, the processing further includes: parsing the demodulated upgrade data utilizing a user predetermined parameter value, to get data related with the user predetermined parameter value.

In an example, the predetermined parameter is the parameters PID and Table ID in the DVB-C standard.

In an example, the steps further include: requesting corresponding upgrade data via the cable digital television interface utilizing a user predetermined parameter value.

In an example, the storage further stores data of an upgrade application which facilitates the upgrade of the to-be-upgraded device, and the steps further include: querying whether the to-be-upgraded device is installed with the upgrade application and it is the latest, and correspondingly sending data for installing or upgrading the upgrade application to the to-be-upgraded device in response to a negative query result.

In an example, the apparatus further includes a parameter setting interface configured to take a user input as the predetermined parameter.

An embodiment of a third aspect of the disclosure further proposes a computer program product for upgrading a to-be-upgraded device, which is stored on a non-volatile computer readable medium and includes an instruction, which instruction, when executed in a processor, implements the following steps: obtaining upgrade data, parsing the upgrade data according to the predetermined parameter value in the upgrade data to get data related with the user predetermined parameter value, performing integrity check on the parsed upgrade data, and upgrading the to-be-upgraded device utilizing the parsed data in response to that the check result is complete.

In an example, upgrade data is obtained again in response to that the check result is incomplete.

An embodiment of a fourth aspect of the disclosure further proposes a method for issuing data for upgrading a to-be-upgraded device, which includes: creating upgrade data required for upgrading the to-be-upgraded device, packaging the upgrade data to support the cable digital television transmission protocol and enable transmission over a cable digital television network, and modulating the packaged upgrade data to the frequency point of a predetermined cable digital television signal.

In an example, the creating is conducted in response to a user request.

In an example, the frequency point is set by a user and is contained in the request. Additional aspects and advantages of the disclosure will be partially given in the following description, and part will become clear from the following description, or learned about by the practice of the disclosure.

### BRIEF DESCRIPTION OF THE DRAWINGS

The above and/or additional aspects and advantages of the disclosure will become clear and easily understood from the description of embodiments in conjunction with the accompanying drawings, wherein:

FIG. 1 shows a schematic diagram of an application environment according to a specific embodiment of the disclosure;

FIG. 2 shows a method flow chart for a front-end server of a cable digital television according to an embodiment of the disclosure;

FIG. 3 shows a method flow chart for a conversion device according to an embodiment of the disclosure;

FIG. 4 shows a method flow chart for an upgrade application according to an embodiment of the disclosure;

FIG. 5 shows a structure schematic diagram of a conversion device according to an embodiment of the disclosure; and

FIG. 6 shows a parameter setting interface of a conversion device according to a specific embodiment of the disclosure.

### DETAILED DESCRIPTION OF THE INVENTION

In the following, embodiments of the disclosure will be described in detail, and the examples of the embodiments are shown in the drawings, wherein identical or similar reference signs denote identical or similar elements or elements with identical or similar functions throughout. In the following, the embodiments described with reference to the drawings are exemplary, intended to explain the invention, and may not be understood as limiting to the invention.

In the following, a cable digital television network conversion device of an embodiment of the disclosure and an upgrade method for a system and/or software based thereon.

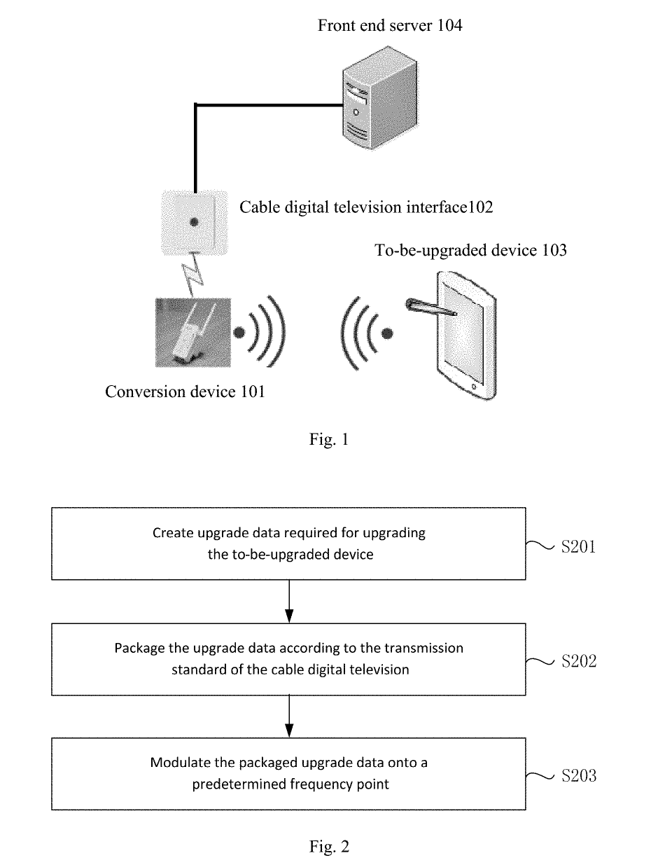

FIG. 1 shows a schematic diagram of an application environment according to a specific embodiment of the disclosure. As shown in FIG. 1, the application environment involves a conversion device 101, a cable digital television interface 102, a to-be-graded device 103 and a front-end server 104. Therein, the conversion device 101 may be connected with the cable digital television interface 102 by plugging in a connector of the cable digital television interface 102, and in turn connected with the front-end server 104. The conversion device 101 may be connected with the to-be-graded device 103 by a wireless network such as wifi. It should be noted that, the wireless network here may further be any other available wireless communication network, especially a short-range wireless communication network, for example, the Bluetooth, the mesh network, the Zigbee, etc. The conversion device may be integrated in a cable digital television or its set-top box. The front-end server 104 is a universal front-end server for cable digital television networks, and is generally used for providing a cable digital television signal, which is provided to a cable television via the cable digital television interface 102. However, in this context, our conversion device 101 also obtains upgrade data from the universal front-end server 104 of a cable digital television network by the cable digital television interface 102, and then transmits it to the to-be-graded device 103 for upgrade by a short-range wireless communication network. The to-be-graded device 103 is generally a smart device installed with a smart system, including, but not limited to, any device of which the system and/or applications may be upgraded, such as a mobile phone, a tablet computer, a smart television, a household smart device (such as a smart telephone, a smart sweeper, a smart washing machine, a smart door and window, etc.), wherein the system includes, but is not limited to, the Android system. After the conversion device 101 is connected with the cable digital television interface 102 and is started, it may be wirelessly connected with the to-be-graded device 103 that is running automatically or manually. For example, the cable digital television interface 102 may automatically open the wifi-direct direction connection function, wherein, for example, its device name is cable_device, and then the wifi-direct direction connection function of the to-be-graded device 103 is enabled, wherein the name of the to-be-graded device 103 is android_device. Afterwards, the android_device is in a paired connection with the cable_device.

FIG. 2 shows a method flow chart for a front-end server of a cable digital television according to an embodiment of the disclosure. At the step S201, the front-end server 104 can create upgrade data required for upgrading the to-be-upgraded device, which may be differential data (which may be in the form of a compressed package) for upgrade. In an example, there may be differential data for upgrading different versions, for example, differential data (which may be in the form of a compressed package) for upgrade with respect to different low-level versions. At the step S202, according to the transmission standard of the cable digital television, e.g., the existing DVB-C (Digital Video Broadcasting-Cable) standard, the different upgrade data is packaged to different Tables and further packaged into different TS (Transport Stream) streams, wherein a TS stream is identified by a PID, for example, a TS stream corresponds to a class of upgrade data, and the Tables are differentiated by the Table ID parameter. At the step S203, the front-end server 104 modulates the TS stream, and in particular, modulates it onto a relatively high frequency point to be suitable for long distance transmission, which frequency point is generally predetermined, and is known to the conversion device 101 or the user.

In a one-way embodiment, issuing the upgrade data by the front-end server 104 is one-way, that is, not issued at the request of the user, and at this point, the predetermined frequency point is set at the front-end server 104 side, and the user cannot change it but only follow it. In this embodiment, the modulated upgrade data may include various differential data (which may be in the form of a compressed package) for upgrade with respect to different low-level versions.

In an interactive embodiment, the front-end server 104 supports interaction with the conversion device 101, then the step S204 may conduct targeted delivery in response to the request of the conversion device 101, and at this point, the frequency point may also be determined depending on the user setting. In this embodiment, the modulated upgrade data may only include the requested upgrade data. The data may still be differentiated according to the PID and further the Table ID parameter.

The embodiments of the disclosure packages the upgrade data by the front-end server 104, modulates it onto a frequency point of the cable digital television signal, pushes it to the to-be-upgraded device after it is converted by the conversion device 101, and eventually finishes the upgrade of the system and/or software by the to-be-upgraded device according to the upgrade data, which solves the problem that the upgrade of the system and/or software cannot be done in a case in which the to-be-upgraded device cannot be connected to the internet.

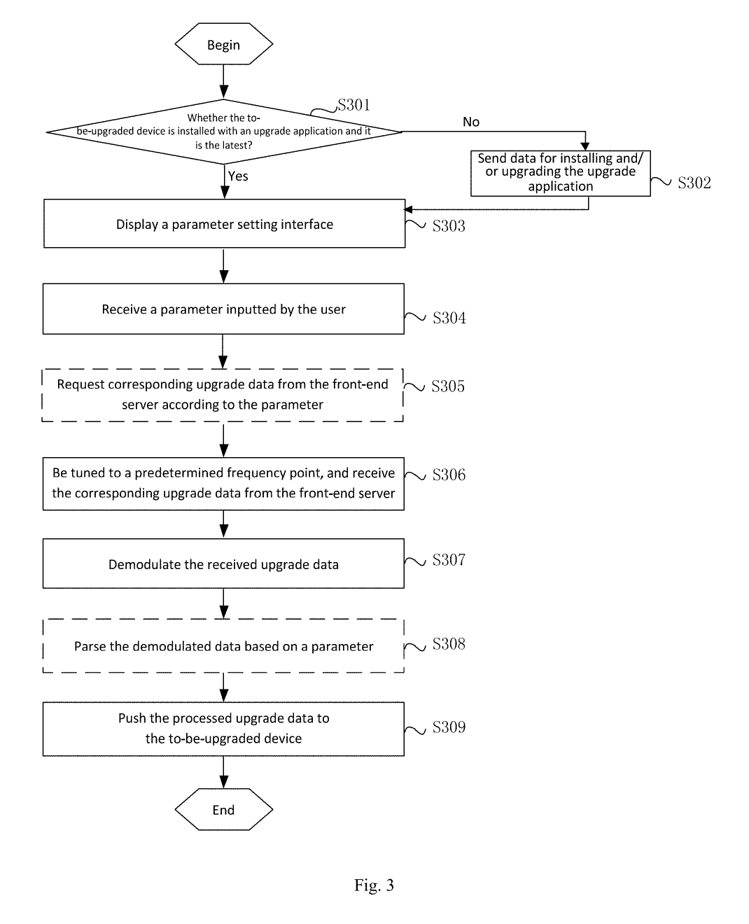

FIG. 3 shows a method flow chart for a conversion device according to an embodiment of the disclosure. At the step S301, it is first queried whether the to-be-upgraded device 103 is installed with an upgrade application and it is the latest. If the to-be-upgraded device 103 is not yet installed with an upgrade application or the version of the installed application is lower than that stored in the conversion device, then at the step S302 the conversion device 101 sends data for installing or upgrading the upgrade application to the to-be-upgraded device 103, and then it proceeds to the step S303. If the to-be-upgraded device 103 is already installed with an upgrade application and the version of the installed application is the same as that stored in the conversion device, then it will not conduct any installation or transmission of the upgrade data, and directly proceed to the step S303.

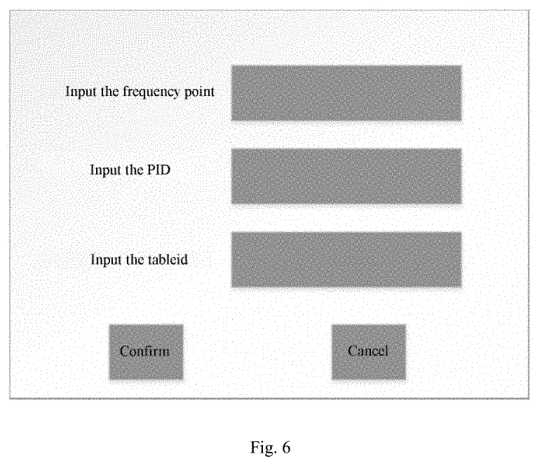

At the step S303, the conversion device 101 displays a parameter setting interface for parameter setting by the user. As shown in FIG. 6, parameters that need to be set for example include the frequency point parameter, the PID parameter and the table id parameter. At the step S304, the above parameters inputted by the user are received. These parameters may be set by any form of input apparatus such as a keyboard, a touch screen, etc. For example, the frequency point parameter may be set to 333 Mhz, and thus the conversion device 101 may receive the upgrade data from the frequency point of 333 Mhz. For different upgrade data, its corresponding PID parameter or even the Table id parameter may be different. Therefore, by setting the PID parameter and the table id parameter, their corresponding upgrade data may thus be determined. In view of that the user's setting of parameters is not that professional, default parameters and a drop-down list with attached explanations may be provided for selection.

In the above-mentioned one-way embodiment, at the step S305, the conversion device 101 requests the upgrade data from the front-end server 104 via the cable digital television interface 10, the above set parameters are contained in this request, and the front-end server 104 will correspondingly issue them according to this request. In the above-mentioned interactive embodiment, there is not the step S305, and the front-end server 104 automatically and continuously issues one or more kind of upgrade data.

At the step S306, the conversion device 101 is tuned to a predetermined frequency point, and receives corresponding upgrade data from the front-end server. It needs to be noted that, in the above-mentioned one-way embodiment, the predetermined frequency point can only be set at the front-end server side, followed at the conversion side, and if it is changed at the front-end server 104 side, the setting is changed correspondingly at the conversion device 102 side, whereas in the above-mentioned interactive embodiment, the setting of the frequency point may employ the same method as above, or also may be self-set by the user and notified to the front-end server 104, as long as it does not conflict with other television signals.

At the step S307, the conversion device 101 demodulates the received upgrade data, and for example, gets the TS data.

It needs to be noted that, if the conversion device is integrated in a digital television or its set-top box, then the steps S306 and S307 may be accomplished utilizing an existing circuit in the set-top box, which is the same as the process of receiving cable digital television program information.

At the step S308, the conversion device 101 further parses the demodulated upgrade data based on a parameter. For example, the TS data is filtered according to the PID parameter and the Table ID parameter, to filter out data unrelated with the predetermined PID value and Table ID value and get the upgrade data corresponding to the PID and Table ID set by the user, that is, for example, restore the differential data (which may be in the form of a compressed package) for upgrade. The step may also be performed in the to-be-upgraded device in another embodiment.

At the step S309, the processed upgrade data is pushed to the to-be-upgraded device for its upgrade. The processed upgrade data may be the parsed data. In another embodiment, the processed data is the demodulated data and the PID parameter and the Table ID parameter for self-parsing by the conversion device 101.

The embodiments of the disclosure converts the upgrade data received via the cable digital television interface into a format that the to-be-upgraded device can read by the conversion device 101, then pushes it to the to-be-upgraded device, and eventually finishes the upgrade by the to-be-upgraded device according to the upgrade data, which solves the problem that the upgrade cannot be done in a case in which the to-be-upgraded device cannot be connected to the internet.

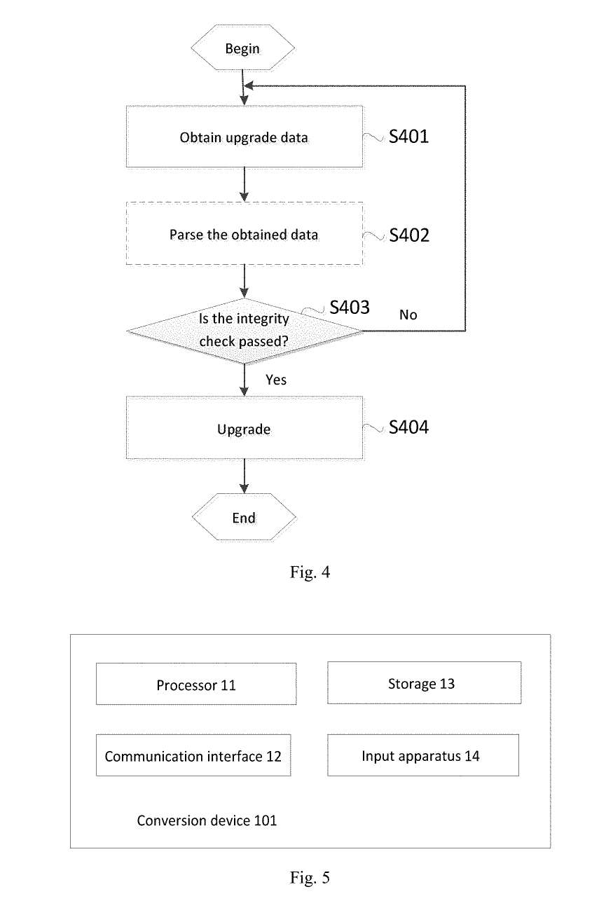

FIG. 4 shows a method flow chart for an upgrade application according to an embodiment of the disclosure. At the step S401, the to-be-upgraded device 103 obtains upgrade data from the conversion device S101, for example, in an embodiment, monitors a TS stream transmitted by the wifi-direct, or alternatively, in another embodiment, monitors a compressed package transmitted by the wifi-direct. In an embodiment, at the step S402, if the obtained upgrade data has not been parsed, the TS data is parsed according to the PID parameter and the Table ID parameter in the upgrade data, to get the upgrade data corresponding to the PID and Table ID set by the user, for example, restore the differential data (which may be in the form of a compressed package) for upgrade. In another embodiment, the step is already done in the conversion device 101, and what is obtained is just for example the differential data (which may be in the form of a compressed package) which may be directly used for upgrade. At the step S403, the upgrade application performs integrity check on the parsed upgrade data obtained at the step S401 or the step S402, for example, compares the check result with the CRC check data, and if they are unequal, it indicates that the parsed upgrade data is incomplete and it is necessary to return to the step S401 again, and if the check is passed, it indicates that the upgrade data is complete, and it proceeds to the step S404 to upgrade the to-be-upgraded device. It needs to be noted that, the upgrade may be to upgrade the system, or also may be to upgrade an application installed on the system. As may be appreciated by the person having ordinary skills in the art, the step may further include system restart.

By an upgrade application, the embodiments of the disclosure receives readable upgrade data converted from a cable digital television signal format from the conversion device 101, and finishes the upgrade of the system and/or software according to the upgrade data, which solves the problem that the to-be-upgraded device cannot accomplish the upgrade of the system and/or software in a case in which it cannot be connected to the internet.

FIG. 5 shows a structure schematic diagram of a conversion device according to an embodiment of the disclosure. As shown in FIG. 5, the conversion device 101 may include a processor 11, a communication interface 12, a storage 13 and an input apparatus 14, wherein the communication interface 12 is used for communicating with the to-be-upgraded device 103 via a wireless communication network, especially a short-range wireless communication network, and communicating with the front-end server 104 via the cable digital television interface 102. In view of the traffic problem of cellular networks, the wireless communication here employs short-range wireless communication. The storage 13 may include volatile and non-volatile, removable and non-removable devices or products which are implemented by any method or technique for storing information, such as a computer readable instruction, a data structure, a program module or other data. By way of example but not in a limiting way, the storage may include a dynamic random access memory (DRAM), a double data rate synchronous dynamic random access memory (DDR SDRAM), a delay reduced DRAM, a solid state memory, a read only memory (ROM), an electrically erasable programmable ROM, an optical disk (e.g., CD-ROM, DVD, etc.), a magnetic disk (e.g., magnetic disk, floppy disk, etc.), a magnetic tape and other type of device and/or product which stores data, for example, which may store an upgrade application for being issued to the to-be-upgraded device and upgrade data for upgrading the to-be-upgraded device. The input apparatus 14 may include any apparatus available for a user to input data, such as a keyboard, a touch screen, etc. The processor 11 includes one or more sub-processor. A sub-processor is a physical device or product including one or more integrated circuit which reads data and instructions from a computer readable medium such as a storage 13 and selectively executes the instructions. In various embodiments, the processor 11 is implemented in various ways. For example, the processor 11 can be implemented as one or more processing core. In another example, the processor 11 can include one or more separate microprocessor. In yet another exemplary embodiment, the processor 11 can include an application-specific integrated circuit (ASIC) which provides specific functionality. In yet another example, the processor 11 provides specific functionality by using an ASIC and by executing computer executable instructions. In this context, the processor is configured to performing the method as described above in conjunction with FIG. 3.

The embodiments of the disclosure converts the received cable digital television signal into the upgrade data required for upgrading the system by the conversion device 101, then pushes it to the to-be-upgraded device, and eventually finishes the upgrade of the system and/or software by the to-be-upgraded device according to the upgrade data, which solves the problem that the to-be-upgraded device cannot accomplish the upgrade of the system and/or software in a case in which it cannot be connected to the internet.

In the description of this specification, a description with reference to the terms “an embodiment”, “some embodiments”, “examples”, etc. indicates that a specific feature, structure, material or characteristic described in conjunction with the embodiment or example is contained in at least one embodiment or example of the disclosure. In this specification, schematic expressions for the above terms need not necessarily point to the same embodiment or example. Moreover, the described specific feature, structure, material or characteristic may be combined in an appropriate way in any one or more embodiment or example. In addition, in the case of no contradiction, the person having ordinary skills in the art may incorporate and combine different embodiments or examples described in the specification and features of the different embodiments or examples.

In addition, the terms “first”, “second” are only used for the purpose of description, and may not be understood as indicating or implying relative importance or implicitly indicating the number of the indicated technical features. Thus, a feature defined by “first”, “second” may explicitly or implicitly include at least said feature. In the description of the disclosure, the meaning of “more” is at least two, e.g., two, three, etc., unless definitely and specifically defined otherwise.

Any process or method description in the flow charts or described in other way herein may be understood as representing a module, fragment or part of code including one or more executable instruction for carrying out steps of a customized logic function or process, and the scope of a preferred embodiment of the disclosure includes additional implementations, wherein a function may not be performed in the shown or discussed order, including in a basically simultaneous manner or in the reverse order according to the involved function, which should be understood by the person having ordinary skills in the art that the embodiments of the disclosure pertain to.

Logics and/or steps represented in a flow chart or described in other ways herein, for example, an ordered list of executable instructions that may be considered to be used for achieving a logic function, may be specifically implemented in any computer readable medium for being used by instruction execution systems, apparatuses or devices (e.g., computer based systems, systems including a processor or other systems that may take an instruction from an instruction execution system, apparatus or device and execute the instruction), or used in combination with the instruction execution systems, apparatuses or devices. As far as this specification is concerned, the “computer readable medium” may be any apparatus which may contain, store, communicate, propagate or transmit a program for being used by instruction execution systems, apparatuses or devices or used in combination with the instruction execution systems, apparatuses or devices. More specific examples (a non-exhaustive list) of the computer readable medium include the following: an electrical connection part (electronic apparatus) with one or more wiring, a portable computer disk cartridge (magnetic apparatus), a random access memory (RAM), a read only memory (ROM), an erasable programmable read only memory (EPROM or flash memory), an optical fiber apparatus, and a portable optical disk read only memory (CDROM). In addition, the computer readable medium may even be paper or other suitable medium on which a program may be printed, because it may be possible to for example perform optical scanning on the paper or other medium, then edit, compile or process it in other suitable manner when necessary, to obtain the program electronically, and then store it in a computer storage.

It should be understood that, various parts of the disclosure may be implemented by hardware, software, firmware or a combination thereof. In the above embodiments, multiple steps or methods may be implemented by firmware or software that is stored in a storage and executed by a suitable instruction execution system. For example, if implemented by hardware, as in a further embodiment, they may be implemented by any one or a combination of the following techniques well known in the art: a discrete logic circuit with a logic gate circuit for achieving a logic function for a data signal, an application specific integrated circuit with a suitable combinational logic gate circuit, a programmable gate array (PGA), a field programmable gate array (FPGA), etc.

It may be appreciated by the person having ordinary skills in the art that implementation of all or part of the steps carried in the methods of the above embodiments may be done by related hardware instructed by a program. The program may be stored in a computer readable storage medium, and when executed, the program includes one or a combination of the steps of the method embodiments.

In addition, various functional units in various embodiments of the disclosure may be integrated in a processing module, or also various units may exist physically separately, or also two or more units may be integrated in a module. The integrated module may be implemented either in the form of hardware, or in the form of a software function module. If implemented in the form of a software function module and sold or used as a stand-alone product, the integrated module may also be stored in a computer readable storage medium.

Although the embodiments of the disclosure have already been illustrated and described in the above, it may be appreciated that the above embodiments are exemplary, and may not be understood as limiting the invention, and the person having ordinary skills in the art may make changes, modifications, replacements and variations to the above embodiments within the scope of the invention.

1. A method for upgrading a to-be-upgraded device, including the steps of:
receiving upgrade data in a cable digital television signal format which is required for upgrading the to-be-upgraded device at a predetermined frequency point via a cable digital television interface,
processing the upgrade data and converting it into a format readable to the to-be-upgraded device, and
sending it to the to-be-upgraded device via a short-range wireless network.

2. The method as claimed in claim 1, wherein the step of processing includes:
demodulating the received upgrade data.

3. The method as claimed in claim 2, wherein the step of processing further includes:
parsing the demodulated upgrade data utilizing a user predetermined parameter value, to get data related with the user predetermined parameter value.

4. The method as claimed in claim 3, wherein the predetermined parameter is the parameters PID and Table ID in the DVB-C standard.

5. The method as claimed in claim 1, further including:
requesting corresponding upgrade data via the cable digital television interface utilizing a user predetermined parameter value.

6. The method as claimed in claim 1, further including:
querying whether the to-be-upgraded device is installed with an upgrade application which facilitates the upgrade of the to-be-upgraded device and it is the latest, and
correspondingly sending data for installing or upgrading the upgrade application to the to-be-upgraded device in response to a negative query result.

7. An apparatus for upgrading a to-be-upgraded device, including:
a storage configured to store an instruction,
a communication interface configured to be capable of communicating with the to-be-upgraded device via a short-range wireless communication network and communicating via a cable digital television interface, and
a processor configured to, when executing the instruction, enable implementation of the following steps:
receiving upgrade data in a cable digital television signal format which is required for upgrading the to-be-upgraded device at a predetermined frequency point via the cable digital television interface,
processing the upgrade data and converting it into a format readable to the to-be-upgraded device, and
sending it to the to-be-upgraded device via a short-range wireless network.

8. The apparatus as claimed in claim 7, wherein the processing includes:
demodulating the received upgrade data.

9. The apparatus as claimed in claim 8, wherein the processing further includes:
parsing the demodulated upgrade data utilizing a user predetermined parameter value, to get data related with the user predetermined parameter value.

10. The apparatus as claimed in claim 9, wherein the predetermined parameter is the parameters PID and Table ID in the DVB-C standard.

11. The apparatus as claimed in claim 7, wherein the steps further include:
requesting corresponding upgrade data via the cable digital television interface utilizing a user predetermined parameter value

12. The apparatus as claimed in claim 7, wherein
the storage further stores data of an upgrade application which facilitates the upgrade of the to-be-upgraded device, and
the steps further include:
querying whether the to-be-upgraded device is installed with the upgrade application and it is the latest, and
correspondingly sending data for installing or upgrading the upgrade application to the to-be-upgraded device in response to a negative query result.

13. The apparatus as claimed in claim 7, further including a parameter setting interface configured to take a user input as the predetermined parameter.

14. A computer program product for upgrading a to-be-upgraded device, which is stored on a non-volatile computer readable medium and includes an instruction, which instruction, when executed in a processor, implements the following steps:
obtaining upgrade data,
parsing the upgrade data according to the predetermined parameter value in the upgrade data to get data related with the user predetermined parameter value,
performing integrity check on the parsed upgrade data, and
upgrading the to-be-upgraded device utilizing the parsed data in response to that the check result is complete.

15. The computer program product as claimed in claim 14, wherein upgrade data is obtained again in response to that the check result is incomplete.
